(19) United States
(12) Patent Application Publication
(10) Pub. No.: US 2005/0240860 A1
(43) Pub. Date: Oct. 27, 2005

(54) Printing method and print system

(75) Inventors: Koichi Gohara, Kanagawa (JP); Hiroshi Murakami, Kanagawa (JP); Kei Yamaji, Kanagawa (JP); Hajime Araya, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/106,693

(22) Filed: Apr. 15, 2005

(30) Foreign Application Priority Data
Apr. 15, 2004 (JP) 2004-120442

(51) Int. Cl. G06F 17/00; G06F 15/00

(52) U.S. Cl. 715/500.1; 715/526; 715/720; 715/730; 345/581

(57) ABSTRACT

A print system is provided with an order receiving device, a frame reproducing device and a printing device. The order receiving device acquires a time stamp of a frame to be printed during producing a photo movie. The frame reproducing device reproduces the frame to be printed by re-editing a still image in higher quality then when producing the frame based on a scenario after specifying the scenario corresponding to the time stamp. The printing device prints the reproduced frame of high quality. In the order receiving device, a photo movie is produced and displayed on a monitor for access of a client to designate the frame to be printed by using an operation section.

### BACKGROUND OF THE INVENTION

1. Field of the Invention

The present invention relates to a method and a system for printing a frame in a photo movie.

2. Background Arts

A photo movie is an image sequence formed by editing plural still images (including a template image) as like a moving picture after the still images have been processed based on a scenario or script. A print ordering device for printing one frame in the photo movie is proposed. (see Japanese Patent Laid-Open Publication No. 2004-64285). In this print ordering device, the still image corresponding to the frame can be specified based on position information of the frame in the photo movie being produced and displayed.

However, in the above print ordering device, although the still image constituting the frame in the photo movie can be printed, the frame to which special effects are applied can not be printed. Although the print ordering device may be improved so as to print the frame itself, since the photo movie generally has a VGA (Video Graphics Array) size (640 pixels in the horizontal direction and 480 pixels in the vertical direction), even if the frame in the photo movie is printed without any processes, a high-quality print of commercial value can not be obtained.

### SUMMARY OF THE INVENTION

An object of the present invention is to provide a method and a system of printing a frame in a photo movie in high quality.

To achieve the above and other objects, a printing method of a photo movie in the present invention, a time stamp for designating a frame to be printed is acquired. The frame designated by the time stamp is reproduced to be printed in high quality by re-editing a still image in high quality suitable for printing based on the scenario after the scenario corresponding to the time stamp has been specified.

According to the preferred embodiment of the present invention, the image, the scenario and the photo movie are recorded on the same recording media.

The print system of the present invention is provided with a time stamp acquisition device, a frame reproducing device and a printing device. The time stamp acquisition device acquires a time stamp for designating a frame to be printed during producing the photo movie. The frame reproducing device reproduces the frame designated by the time stamp by re-editing the image in image quality suitable for printing based on the scenario after the scenario corresponding to the time stamp has been specified. The printing device prints the reproduced frame of high quality. The time stamp acquisition device is preferably provided with an operation unit for making a user select the frame to be printed.

According to the printing method and the print system of the present invention, the frame to be printed is reproduced by re-editing the still image in image quality suitable for printing based on the scenario specified by the time stamp. The reproduced frame of high quality is used for printing, so that the frame in the photo movie can be printed in high quality.

### BRIEF DESCRIPTION OF THE DRAWINGS

The above objects and advantages of the present invention will become apparent from the following detailed descriptions of the preferred embodiments when read in association with the accompanying drawings, which are given by way of illustration only and thus do not limit the present invention. In the drawings, the same reference numerals designate like or corresponding parts throughout the several views, and wherein:

FIG. 1 is a schematic view showing a constitution of a print system of the present invention;

FIG. 2 is an explanatory view showing a format of a scenario;

FIG. 3 is a block diagram showing an internal constitution of a frame reproducing device; and

FIG. 4 is a flow chart showing processing procedure in the print system.

### DETAILED DESCRIPTION OF THE EMBODIMENTS

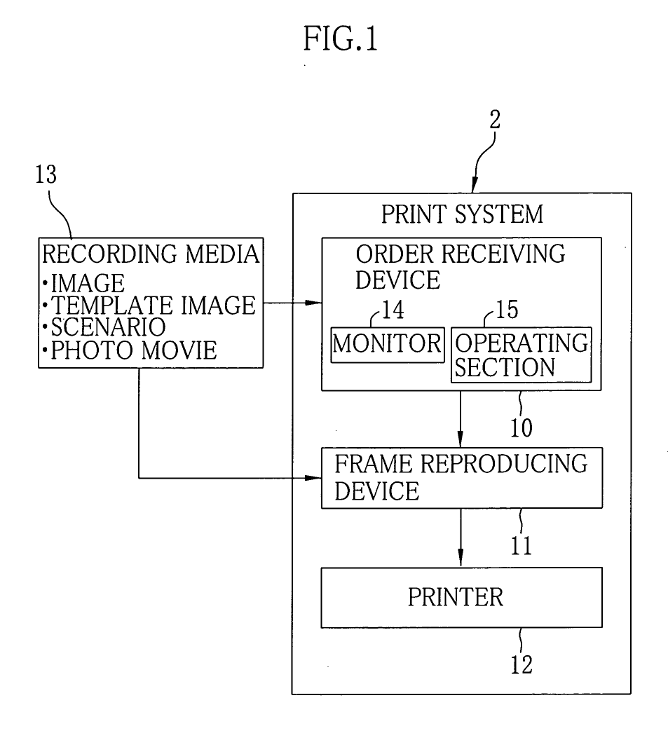

In FIG. 1, a print system 2 of the present invention is constituted of an order receiving device 10 as a time stamp acquisition device, a frame reproducing device 11, and a printer 12. The print system 2 is operated to edit a still image (hereinafter referred to as an image) based on a scenario for specifying a display form of the image to print each frame in a photo movie or image sequence.

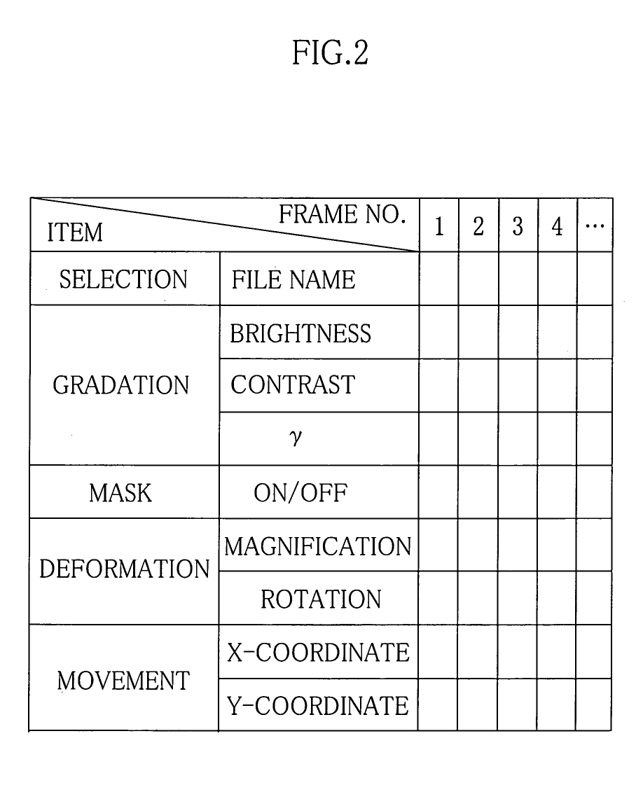

As shown in FIG. 2, with respect to the scenario or secenario, a file name of the image constituting the frame in the photo movie, a gradation correction value (brightness, contrast, and gamma correction value), presence of a mask, a deformation parameter (enlargement or reduction magnification, and rotation) and various parameters such as a movement parameter (X-Y coordinates) are designated for each frame in the photo movie. Note that the frame rate of the photo movie is set to 1/60 sec., for example.

The order receiving device 10 in FIG. 1 is placed in a DPE shop and a convenience store, and receives the print order or customer order through a recording media 13 or storage such as a DVD (Digital Versatile Disk) in which the plural images, a template image, the scenario and the photo movie are recorded. The image is a digital image obtained by reading optically the image recorded in a photographic film or a recording paper, or obtained by an image pickup device including a digital camera and a portable telephone with camera. Additionally, the image includes the template image such as a background image and a mask image. These images usually have 3,000,000 pixels.

The order receiving device 10 is provided with a monitor 14 and an operating section 15. The photo movie read in the recording media 13, order menu and so forth are produced and displayed on the monitor 14. The operating section 15 is constituted of a keyboard, a mouse, a touch panel and so forth, and operated when order information including the frame to be printed, personal information, print size (e.g., L size, 2L size), the number of prints and print delivery date is inputted.

The order receiving device 10 acquires the time stamp of the frame ordered to be printed when the operating section 15 is operated, and then sends the time stamp to the frame reproducing device 11. The time stamp is information representing a position of frames in the photo movie, specifically an elapsed time from starting of the playback. The information may represent a frame number.

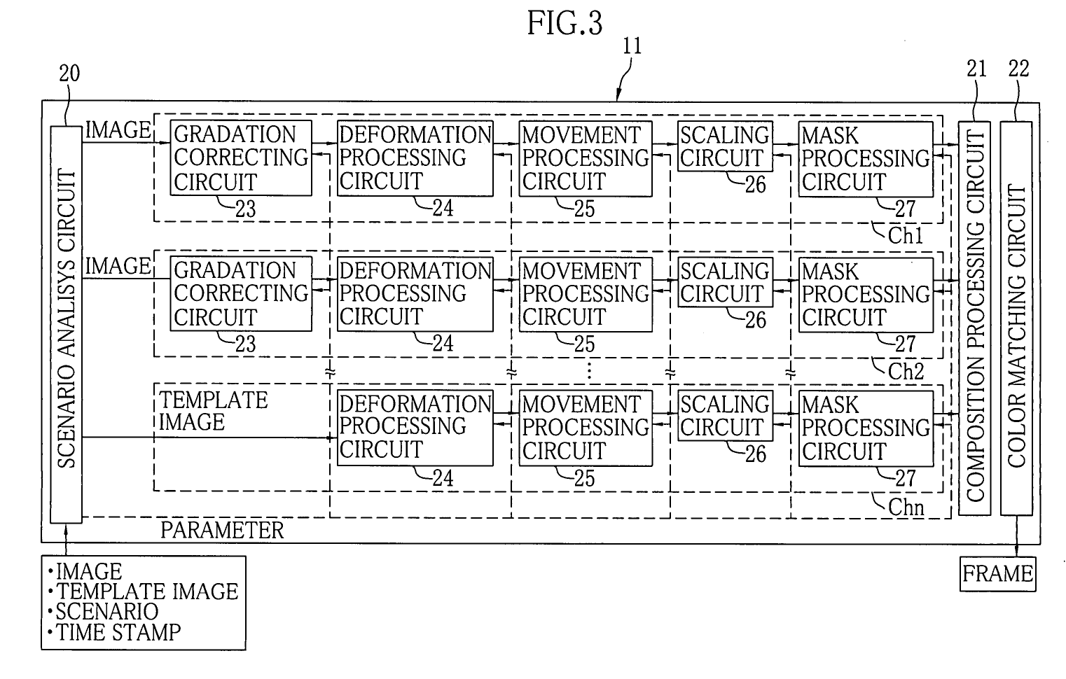

As shown in FIG. 3, the frame reproducing device 11 is constituted of processing channels Ch1 to Chn, a scenario analysis circuit 20, a sequence-combining composition processing circuit 21 and a color matching circuit 22. The frame reproducing device 11 reproduces the frame to be printed based on the time stamp from the order receiving device 10, the image and the template image in the recording media 13, and the scenario.

The processing channels Ch1 to Chn-1 applying various kinds of processing to the image are respectively provided with a gradation correcting circuit 23, a deformation processing circuit 24, a movement processing circuit 25, a scaling circuit 26 and a mask processing circuit 27. The processing channel Chn has the same constitution as the channels Ch1-Chn-1 except that there is not the gradation correcting circuit 23, and applies the various kinds of processing to the template image.

The gradation correcting circuit 23 applies gradation correction to the image based on the gradation correcting value written in the scenario. As the example, a color image is converted into a black and white image, or into the monochromatic sepia color-tone, so that a special effect is given to the image as if the printed image was an old photograph.

The deformation processing circuit 24 applies a deformation process to the image based on the deformation parameter written in the scenario. As the example, a specified portion of the image is enlarged or reduced, so that a special effect is given to the image as if zooming operation was performed.

The movement processing circuit 25 applies the movement process to the image based on the movement parameter written in the scenario. As the example, a certain region is taken out of the image, and then moved in the image, so that a special effect is given to the image as if pan operation was performed.

The scaling circuit 26 changes image pixel size in accordance with the print size inputted from the operating section 15. The mask processing circuit 27 applies a mask process to the image. As the example, the mask processing circuit 27 extracts one part of the image and pastes it by synthesis on the template image on which specified characters and patterns are written.

The scenario analysis circuit 20 specifies the scenario corresponding to the time stamp sent from the order receiving device 10 from among the scenario inputted to the recording media 13. The scenario analysis circuit 20 analyzes the specified scenario to supply various parameters written in the scenario in each of the circuits 23-27 in the processing channels Ch1-Chn, and in addition, discriminates the image (including the template image) constituting the frame to be printed from among the images stored in the recording media 13 and allocates the image to each of processing channels Ch1-Chn.

Each of the circuits 23-27 perform various kinds of processing based on various kinds of parameters supplied from the scenario analysis circuit 20. Meanwhile, if the parameter is not designated in the scenario, each circuit transfers the image to its post-stage circuit without performing the processing.

The composition processing circuit 21 combines sequences of the image and the template image to which various kinds of processing are applied in each processing channels Ch1-Chn. The color matching circuit 22 applies the color conversion to the images combined by the composition processing circuit 21 in accordance with the type of the printer 12. Thereby, the frame to be printed is reproduced.

The printer 12 is constituted of the well-known image printing device for example, in which the image displayed on a LCD is projected and exposed in the photosensitive material, and prints the frame reproduced by the frame reproducing device 11 in accordance with the order information. The printer 12 may be a laser printer in which the photosensitive material is exposed by laser beam after modulating intensity of the laser beam in response to a signal of the frame. In addition, the printer 12 may be an ink jet printer or a thermal printer.

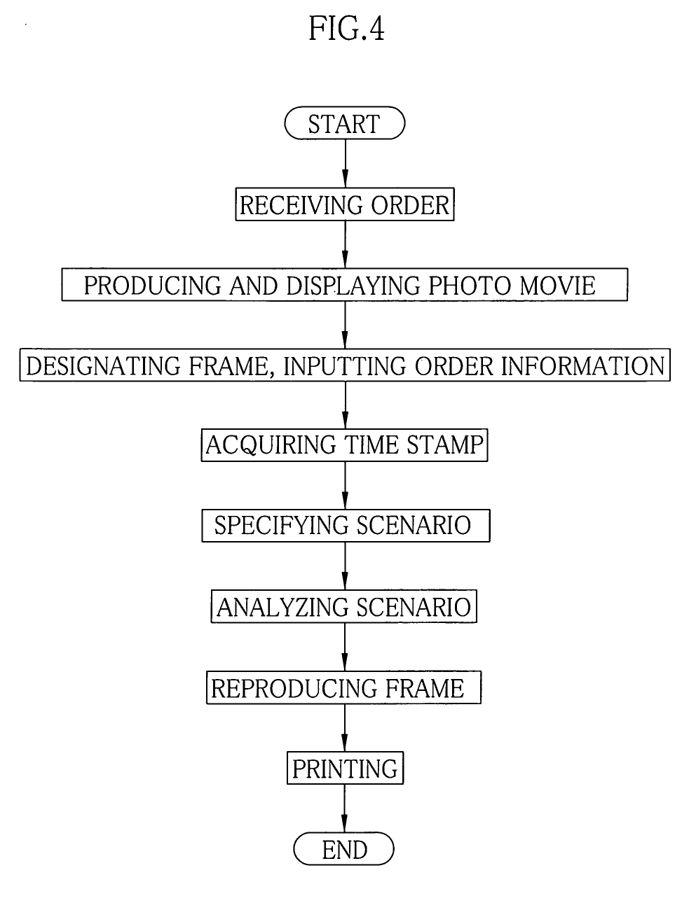

Next, the operation of the print system 2 having the above constitution is explained by referring to the flow chart in FIG. 4. The printing order or customer order for the frame in the photo movie is received by the order receiving device 10. The photo movie read in the recording media 13 is produced and displayed on the monitor 14 of the order receiving device 10. A client designates the frame to be printed or inputs the order information by operating the operating section 15 by referring to the photo movie on the monitor 14.

In the order receiving device 10, the time stamp of the frame ordered to be printed by operating the operating section 15 is acquired to be sent to the frame reproducing device 11.

In the frame reproducing device 11, the frame to be printed is reproduced with the image in high quality suitable for printing based on the time stamp from the order receiving device 10, the image and the template image from the recording media 13, and the scenario. First, in the scenario analysis circuit 20, the scenario corresponding to the time stamp sent from the order receiving device 10 is specified from among the scenarios stored in the recording media 13, and then the scenario is analyzed.

Second, various kinds of parameters written in the scenario specified by the frame reproducing device 11 are supplied from the scenario analysis circuit 20 to each of the circuits 23-27 in the processing channels Ch1-Chn. Meanwhile, the image constituting the frame to be printed is discriminated from among the images stored in the recording media 13, and then allocated to each processing channel.

In each of the circuits 23-27, various kinds of processing are performed based on various kinds of parameters supplied from the scenario analysis circuit 20. When the parameter is not designated in the scenario, the image is transferred to the post-stage circuit of the processing circuits without performing the processing in each processing circuit.

The image and the template image to which various kinds of processing are applied in processing channels Ch1-Chn are combined in the composition processing circuit 21, and then the color matching circuit 22 applies the color conversion to these images according to the type of the printer 12. The reproduced frame of high quality is sent to the printer 12 to be printed in the printer 12 in accordance with the order information.

As above mentioned, after the frame is reproduced from not the frame itself in the photo movie of low image resolution (640×480 pixels), but an original image of the frame of high image resolution (e.g. 3,000,000 pixels), the reproduced frame is printed, so that a high-quality print of commercial value can be obtained. For example, in case of the L size print, the reproduced image has 2024 pixels in the horizontal direction and 1536 pixels in the vertical direction, so that a print having pixels of 10 times relative to the case wherein the frame itself is printed can be obtained.

When the image size is changed in the scaling circuit 26, the image resolution corresponding to the print size may be unavailable according to an enlargement magnification of the image. In such a case, an alarm message is displayed on the monitor 14 before printing, or the client may select which of the image quality and the print size is given priority by the operating section 15. If the image quality is given priority, the enlargement magnification is changed in accordance with the image resolution of the print. Meanwhile, if the print size is given priority, smoothing process such as pixel interpolation is applied to the image without changing the magnification.

Note that the data of all the frames in the photo movie may be recorded in the recording media 13 after the frames are edited so as to have similar image resolution to the original image. Thereby, it becomes unnecessary to reproduce the frame, so that it is possible to speed up the printing process.

In addition, in order to reduce the capacity of the data recorded in the recording media 13, the data of all the frame in the photo movie is not edited, but the data of the frame sampled at an interval of predetermined time, for example, every one second, may be edited and recorded. Moreover, the frame to which the special effect is applied may not be sampled at the interval of the predetermined time, but may be sampled when the specific person is enlarged to be displayed after acquiring the editing condition of the photo movie from the scenario, for example.

In the above embodiment, the embodiment wherein the order receiving device 10 is placed in the DPE shop and the convenience store is explained. However, the present invention is also applicable to the embodiment wherein the order is received from a personal computer of the client through communication network such as internet.

Although the present invention has been described with respect to the preferred embodiment, the present invention is not to be limited to the above embodiment but, on the contrary, various modifications will be possible to those skilled in the art without departing from the scope of claims appended hereto.

1. A printing method of printing a frame in a photo movie in which plural still images are edited based on a scenario for determining a display form of said plural still images, said printing method comprising the steps of:
acquiring a time stamp for specifying said frame to be printed during playback of said photo movie;
specifying said scenario corresponding to said time stamp;
producing said frame designated by said time stamp by re-editing said still image in high quality based on said specified scenario so as to be suitable for printing; and
printing said reproduced frame.

2. A printing method as claimed in claim 1, wherein said still image, plural scenarios including said scenario in which said time stamp is acquired, and said photo movie are recorded in the same recording media.

3. A printing method as claimed in claim 2, wherein said time stamp of said frame is acquired when said frame to be printed is selected by a user while playing back and displaying said photo movie.

4. A printing method as claimed in claim 3, wherein said time stamp is an elapsed time of playback.

5. A print system for printing a frame of photo movie comprising:
a time stamp acquisition device for acquiring a time stamp of said frame to be printed during producing said photo movie;
a frame reproducing device for specifying a scenario corresponding to said time stamp, and for reproducing said frame designated by said time stamp in higher quality than during playback of said frame by re-editing a still image based on said specified scenario; and
a printing device for printing said reproduced frame in high quality.

6. A print system as claimed in claim 5, wherein said still image, plural scenarios including said scenario in which said time stamp is acquired, and said photo movie are recorded in the same recording media.

7. A print system as claimed in claim 6, wherein said time stamp acquisition device is provided with a display for playing back and displaying said photo movie and an operation unit for access of a user to select said frame to be printed.
